(19) United States
(12) Patent Application Publication
(10) Pub. No.: US 2025/0242595 A1
(43) Pub. Date: Jul. 31, 2025

(54) LIQUID EJECTION HEAD AND LIQUID EJECTION APPARATUS

(71) Applicant: RISO Technologies Corporation, Tokyo (JP)

(72) Inventor: Keita TAKAHASHI, Mishima Shizuoka (JP)

(21) Appl. No.: 18/955,862

(22) Filed: Nov. 21, 2024

(30) Foreign Application Priority Data
Jan. 26, 2024 (JP) 2024-010341

(51) Int. Cl. B41J 2/14; B41J 2/045

(52) U.S. Cl. CPC B41J 2/1433; B41J 2/0454

(57) ABSTRACT

A liquid ejection head includes a plurality of nozzle arrays extending along a first direction and through which liquid is ejected towards a second direction perpendicular to the first direction, a plurality of substrates extending along the first and second directions, the substrates corresponding to the nozzle arrays, a plurality of heat generating circuits each disposed on a corresponding one of the substrates, a temperature control structure that contacts the heat generating circuits for controlling temperature thereof, and one or more plate springs each biased to push one or more of the heat generating circuits against the temperature control structure.

### CROSS-REFERENCE TO RELATED APPLICATION

This application is based upon and claims the benefit of priority from Japanese Patent Application No. 2024-010341, filed on Jan. 26, 2024, the entire contents of which are incorporated herein by reference.

### FIELD

Embodiments described herein relate generally to a liquid ejection head and a liquid ejection apparatus.

### BACKGROUND

Liquid ejection heads which eject a liquid such as ink to a medium are known from before. In such liquid ejection heads, a driver IC and so on are mounted on a wiring film coupled to a substrate. Further, it is also known for the liquid ejection heads to have a configuration having a cooling unit having a flow path for controlling the temperature of a heat generator such as the driver IC, and a configuration in which the substrate is held by the cooling unit. Further, when nozzle columns of the liquid ejection head grows in number, a configuration of a head main body, a configuration of a member for cooling the heat generators, and a configuration for holding the substrate become complicated, and therefore, a technology which capable of holding the heat generators and the substrate with ease without growing in size is desired.

### DESCRIPTION OF THE DRAWINGS

FIG. 1 is a perspective view showing a configuration of a liquid ejection head.

FIG. 2 is an exploded perspective view showing the configuration of the liquid ejection head.

FIG. 3 is a side view schematically showing the configuration of the liquid ejection head with a partial cross-sectional view.

FIG. 4 is a cross-sectional view showing the configuration of the liquid ejection head.

FIG. 5 is a diagram showing the configuration of the liquid ejection head from a nozzle plate side.

FIG. 6 is a perspective view showing a configuration of head main bodies and a manifold unit of the liquid ejection head with a partial cross-sectional view.

FIG. 7 is a cross-sectional view showing the configuration of the head main bodies and the manifold unit.

FIG. 8 is a cross-sectional view showing the configuration of the head main bodies and the manifold unit.

FIG. 9 is a diagram showing the configuration of the head main body with a partial omission.

FIG. 10 is an exploded perspective view showing a configuration of a cooling flow path unit.

FIG. 11 is a cross-sectional view showing a configuration of a holding member used in the liquid ejection head.

FIG. 12 is an explanatory diagram showing a configuration of a liquid ejection apparatus.

### DETAILED DESCRIPTION

The present disclosure provides a liquid ejection head and a liquid ejection apparatus capable of easily holding the heat generating part and the substrate without growing in size.

In general, according to one embodiment, a liquid ejection head comprises a plurality of nozzle arrays extending along a first direction and through which liquid is ejected towards a second direction perpendicular to the first direction, a plurality of substrates extending along the first and second directions, the substrates corresponding to the nozzle arrays, a plurality of heat generating circuits each disposed on a corresponding one of the substrates, a temperature control structure that contacts the heat generating circuits for controlling temperature thereof, and one or more plate springs each biased to push one or more of the heat generating circuits against the temperature control structure.

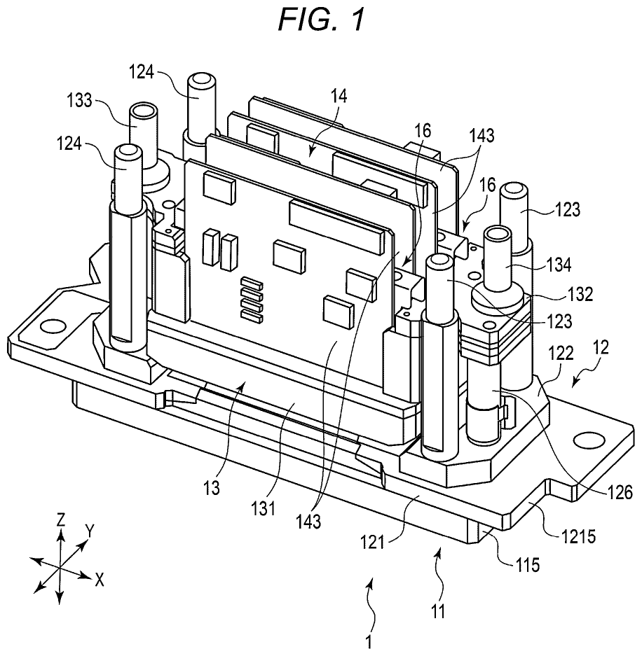

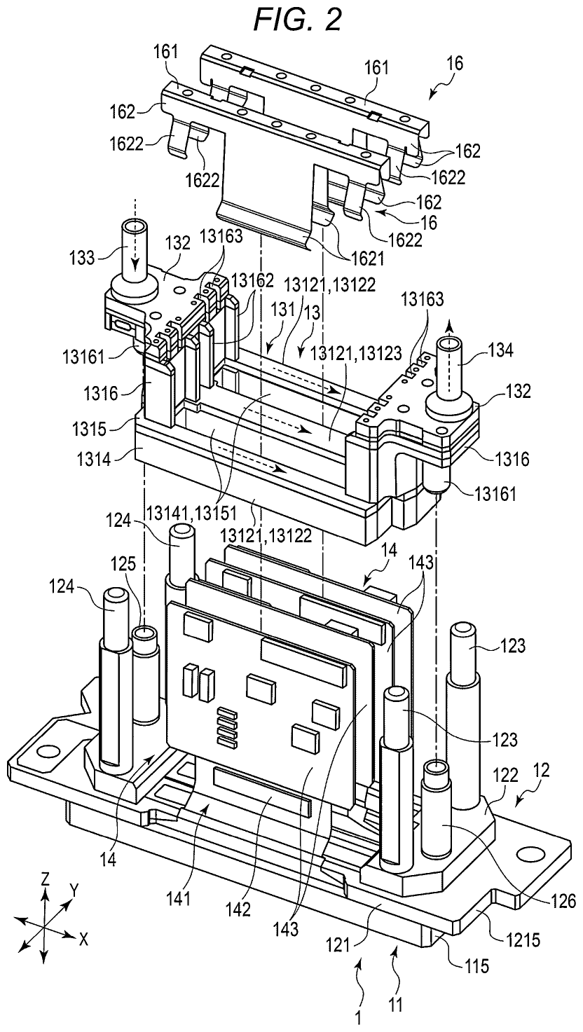

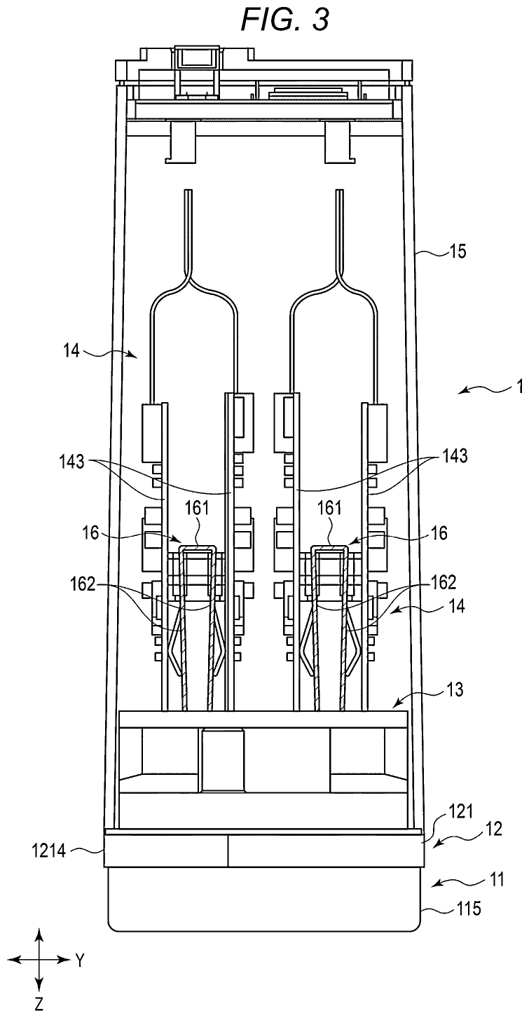

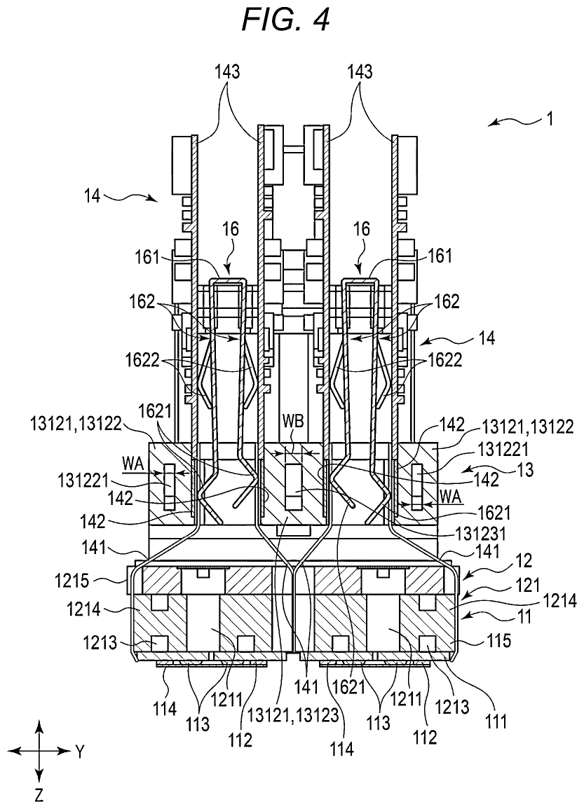

A liquid ejection head 1 and a liquid ejection apparatus 2 using the liquid ejection head 1 according to an embodiment will hereinafter be described with reference to FIG. 1 through FIG. 12. FIG. 1 is a perspective view showing a configuration of the liquid ejection head 1 with a cover 15 omitted. FIG. 2 is an exploded perspective view showing the configuration of the liquid ejection head 1 with the cover 15 omitted, FIG. 3 is a side view schematically showing the configuration of the liquid ejection head 1 with a partial cross-sectional view, and FIG. 4 is a cross-sectional view showing the configuration of the liquid ejection head with the cover 15 omitted.

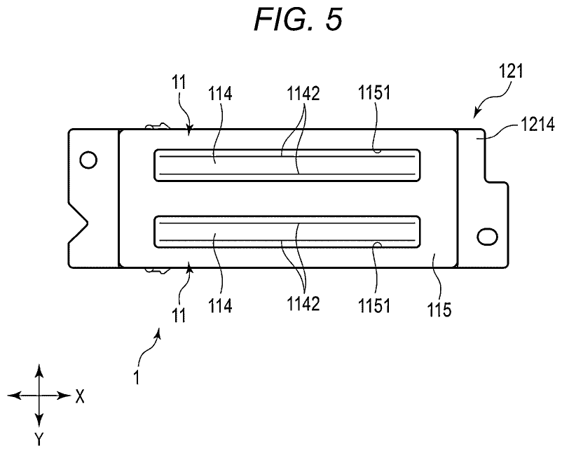

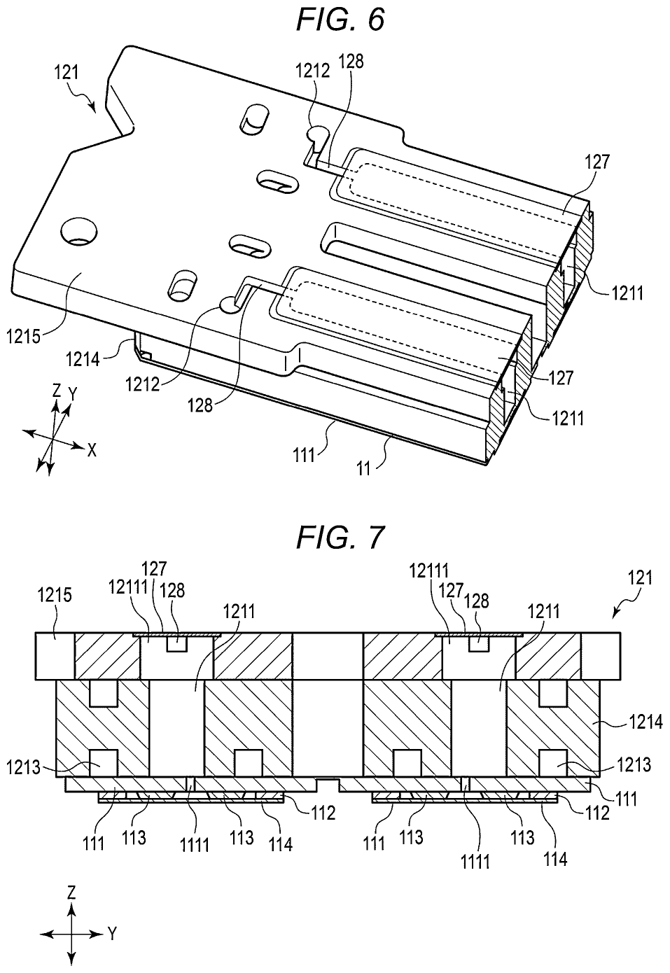

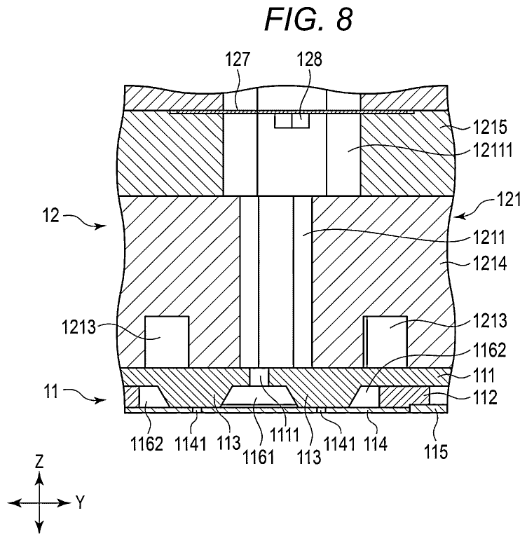

FIG. 5 is a diagram showing the configuration of the liquid ejection head 1 from a nozzle plate 114 side. FIG. 6 is a perspective view showing a configuration of head main bodies 11 and a manifold unit 12 of the liquid ejection head 1 with a partial cross-sectional view, FIG. 7 is a cross-sectional view showing the configuration of the head main bodies 11 and the manifold unit 12, and FIG. 8 is a cross-sectional view showing the configuration of the head main bodies 11 and the manifold unit 12 in an enlarged manner.

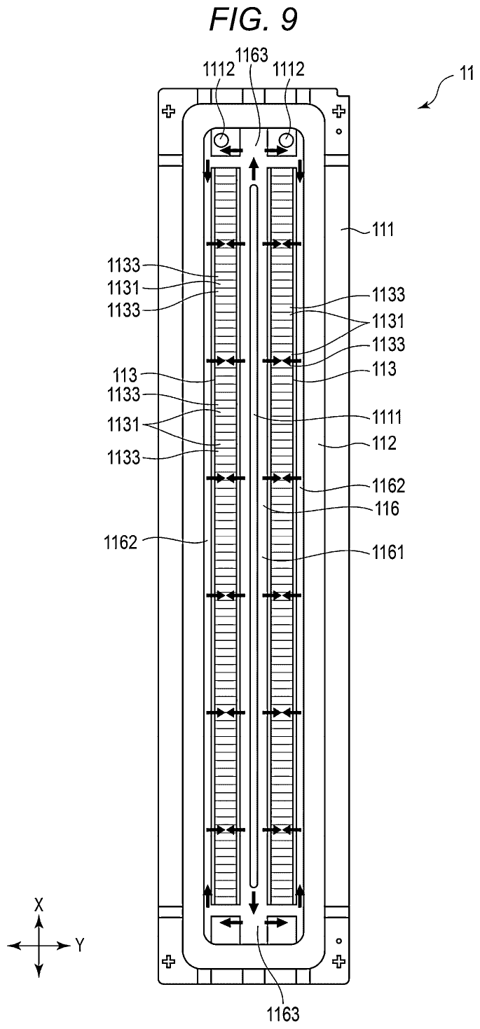

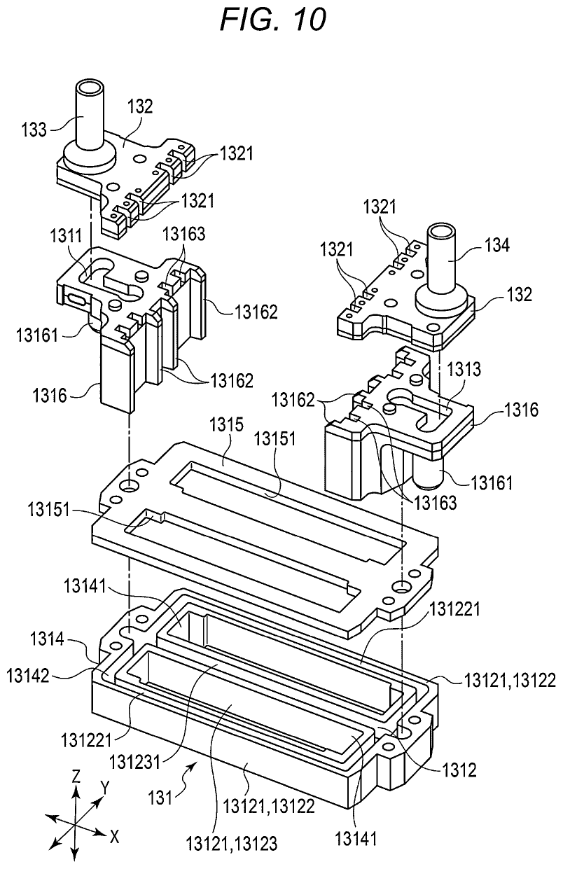

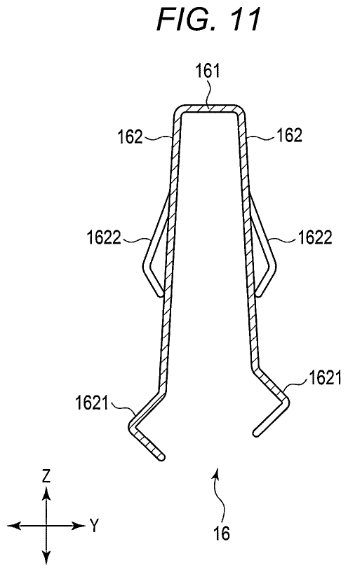

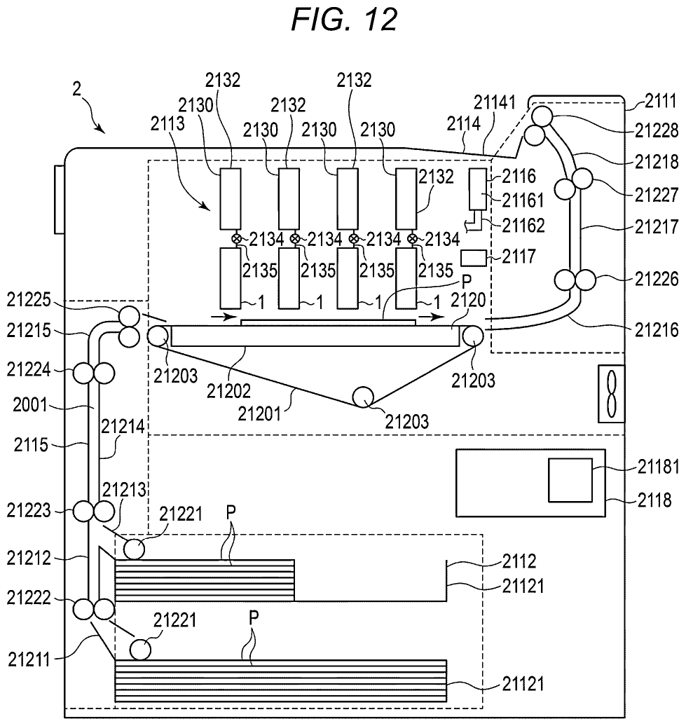

FIG. 9 is a diagram showing the configuration of the head main body 11 with a partial omission. FIG. 10 is an exploded perspective view showing a configuration of a temperature control flow path unit 13 (hereinafter also referred to as a temperature control structure). FIG. 11 is a cross-sectional view showing a configuration of a holding member 16 which holds driver ICs 142 and printed wiring boards or substrates 143 together with the temperature control flow path unit 13. FIG. 12 is an explanatory diagram showing a configuration of the liquid ejection apparatus 2. It should be noted that an example of a flow of cooling water is represented by dotted arrows.

Further, X axis, Y axis, and Z axis perpendicular to each other are illustrated in FIG. 1 through FIG. 11. Further, in the following descriptions, a direction along X axis is defined as a first direction X, a direction along Y axis is defined as a second direction Y, and a direction along Z axis is defined as a third direction Z. Further, the constituents are shown with expansion, contraction, or omission as appropriate in the drawings for the sake of convenience of explanation.

The liquid ejection head 1 is, for example, an inkjet head provided to the liquid ejection apparatus 2 such as an inkjet printing apparatus shown in FIG. 12. The liquid ejection head 1 is disposed in a head unit 2130 including a supply tank 2132 as a liquid container provided to the liquid ejection apparatus 2.

The liquid ejection head 1 is supplied with ink as a liquid retained in the supply tank 2132. It should be noted that the liquid ejection head 1 may be a noncyclic type head which does not circulate ink, or may be a cyclic type head which circulates ink. Here, the liquid ejection head 1 is described using the noncyclic type head. Further, the liquid ejection head 1 is coupled to a temperature control device 2116 which performs temperature control by cooling and/or heating, and which is provided to the liquid ejection apparatus 2, and is supplied with a temperature control liquid which performs the temperature control of a heat generating part and the ink. It should be noted that the temperature control device 2116 performs the temperature control of the ink with the temperature control liquid. Further, the liquid ejection head 1 includes a temperature control liquid circulation structure together with the temperature control device 2116.

As shown in FIG. 1 through FIG. 4, the liquid ejection head 1 is provided with the head main bodies 11, the manifold unit 12, the temperature control flow path unit 13, circuit boards or substrates 14, a cover 15, and the holding members 16. For example, the liquid ejection head 1 is a four-column integral structure head of a side-shoot type having two sets of the head main body 11 having a pair of actuators 113.

The head main body 11 ejects the liquid. As shown in FIG. 3 through FIG. 9, the head main body 11 is provided with base plates 111, frame bodies 112, actuators 113, nozzle plates 114, and a mask plate 115. Further, the head main body 11 has a common liquid chamber 116. Here, the description will be presented using an example in which each of the head main bodies 11 includes two actuators 113.

As shown in FIG. 7 through FIG. 9, the base plate 111 is formed of, for example, a ceramics material so as to have a rectangular plate-like shape. The base plate 111 is formed to have, for example, a rectangular shape elongated in one direction (i.e., the first direction X). As shown in FIG. 9, the base plate 111 has a single supply opening 1111 and a single discharge opening 1112 or a plurality of discharge openings 1112. The base plate 111 is provided with the pair of actuators 113, and at the same time, provided with a wiring pattern for driving the actuators 113. The supply opening 1111 and the discharge openings 1112 are each a through hole penetrating between both principal surfaces of the base plate 111.

The single supply opening 1111 is disposed at a position opposed to, for example, a first common liquid chamber 1161 described later of the common liquid chamber 116. The supply opening 1111 is, for example, an elongated hole elongated in one direction along a longitudinal direction (i.e., the first direction X) of the first common liquid chamber 1161. The supply opening 1111 is, for example, an elongated hole which has a rectangular shape elongated in one direction, or which has semicircular shapes in both end portions and has a uniform width. The width in the longitudinal direction of the supply opening 1111 is set to, for example, a length no shorter than the length in the longitudinal direction of the actuators 113, or a length which is shorter than the length of the actuators 113, and which is in a comparable level to a whole nozzle range in which pressure chambers 1131 driven in normal ink ejection provided to the actuators 113 are disposed.

The two discharge openings 1112 are disposed, for example, at positions opposed to at least one of two third common liquid chambers 1163 described later of the common liquid chamber 116. For example, as shown in FIG. 9, the discharge openings 1112 are provided to the base plate 111 so as to be arranged in one of the third common liquid chambers 1163 adjacent to one end portions in the longitudinal direction of the pair of actuators 113. It should be noted that a configuration in which, for example, the two discharge openings 1112 are provided to each of the two third common liquid chambers 1163 of the common liquid chamber 116 may be adopted.

As shown in FIG. 9, the frame body 112 is fixed to one of the principal surfaces of the base plate 111 with an adhesive or the like. The frame body 112 surrounds the supply opening 1111, the plurality of discharge openings 1112, and the actuators 113, which are provided to the base plate 111.

For example, the frame body 112 is formed to have a rectangular frame shape elongated in one direction (i.e., the first direction X) to thereby form an opening elongated in one direction along the longitudinal direction of the frame body 112. The pair of actuators 113, the supply opening 1111, and the two discharge openings 1112 are arranged in the opening of the frame body 112.

The actuator 113 is formed to have a plate-like shape elongated in one direction (i.e., the first direction X). The pair of actuators 113 are bonded to a mounting surface of the base plate 111. As shown in FIG. 9, the pair of actuators 113 are disposed so as to be arranged in two columns in a transverse direction (i.e., the second direction Y) perpendicular to the longitudinal direction of the actuators 113 across the supply opening 1111. The actuators 113 are arranged in the opening of the frame body 112, and are bonded to the principal surface of the base plate 111. As a specific example, the actuators 113 are each formed by bonding two piezoelectric materials each having a rectangular plate-like shape elongated in one direction to each other so that the respective polarization directions are opposite to each other. Here, the piezoelectric materials are, for example, lead zirconate titanate (PZT). The actuators 113 are bonded to the mounting surface of the base plate 111 with, for example, an epoxy adhesive having a thermoset property.

The actuators 113 each have, for example, a plurality of pressure chambers 1131 arranged at regular intervals in the longitudinal direction (i.e., the first direction X). The actuators 113 are each provided with a plurality of grooves in the longitudinal direction of the actuators 113 at an opposite principal surface side to the base plate 111 side, and the pressure chambers 1131 are formed of the grooves. In other words, the actuators 113 each have a plurality of walls 1133 which are arranged at regular intervals in the longitudinal direction, and which have the grooves formed therebetween. The plurality of walls 1133 forms the plurality of pressure chambers 1131, wherein each of the pressure chambers 1131 is formed between the walls 1133 adjacent to each other. In other words, the plurality of walls 1133 is each a partition wall which partitions the plurality of pressure chambers 1131. Further, the walls 1133 are each a piezoelectric body as a drive element which varies the volume of the pressure chamber 1131 in response to application of a drive voltage.

A surface of the actuator 113 at an opposite side in the third direction Z to the base plate 111 is bonded to the nozzle plate 114. Further, the actuator 113 is provided with a wiring pattern for driving the plurality of pressure chambers 1131.

The pressure chambers 1131 are each a pressure chamber for jetting the ink from nozzles 1141 when performing an operation such as printing by the liquid ejection head 1. It should be noted that although the example in which the actuators 113 each have the plurality of pressure chambers 1131 is described, a configuration in which, for example, air chambers which are arranged alternately with the plurality of pressure chambers 1131, and which do not eject the ink are provided can also be adopted.

As shown in FIG. 4, FIG. 5, FIG. 7, and FIG. 8, the nozzle plate 114 is formed to have a plate-like shape. The nozzle plate 114 is fixed, with an adhesive or the like, to a principal surface of the frame body 112 at an opposite side to the base plate 111 in a direction (i.e., the third direction Z) in which the base plate 111 and the nozzle plate 114 are opposed to each other. The nozzle plate 114 has the plurality of nozzles 1141 formed at positions opposed to the plurality of pressure chambers 1131. In this example, the nozzle plate 114 has two nozzle arrays 1142 each having the plurality of nozzles 1141 arranged in one direction (i.e., the first direction X). Since the liquid ejection head 1 has the two sets of the head main body 11, the liquid ejection head 1 has four nozzle arrays 1142 as shown in FIG. 5.

The plurality of nozzles 1141 opposed to the plurality of pressure chambers 1131 is each a hole for jetting the ink when performing the operation such as printing by the liquid ejection head 1.

The mask plate 115 covers, for example, a principal surface at an outer surface side of the nozzle plate 114, an outer circumferential side of the nozzle plate 114, an outer circumferential surface of the frame body 112, and an outer circumferential surface of the base plate 111. Further, the mask plate 115 covers first manifolds 1214 described later of the manifold unit 12.

As shown in FIG. 5, the mask plate 115 has a pair of windows 1151 which expose the nozzle arrays 1142 formed of the plurality of nozzles 1141 which is provided to the pair of nozzle plates 114, and which ejects the liquid.

As shown in FIG. 9, the common liquid chamber 116 is communicated with the supply opening 1111. The common liquid chamber 116 is disposed on the periphery of the pair of actuators 113. Specifically, the common liquid chamber 116 is communicated with a primary side and a secondary side of the plurality of pressure chambers 1131 of each of the actuators 113. Further, the common liquid chamber 116 is communicated with the discharge openings 1112.

For example, as shown in FIG. 9, the common liquid chamber 116 has the first common liquid chamber 1161 elongated in one direction (i.e., the first direction X), two second common liquid chambers 1162 elongated in one direction (i.e., the first direction X), and third common liquid chambers 1163 which communicate both ends of the first common liquid chamber 1161 and both ends of the two second common liquid chambers 1162 with each other. Further, the common liquid chamber 116 communicates the supply opening 1111 and one openings of the plurality of pressure chambers 1131 of the actuators 113 with each other with the first common liquid chamber 1161, and communicates the third common liquid chambers 1163 and the other openings of the plurality of pressure chambers 1131 with each other with the second common liquid chambers 1162.

The first common liquid chamber 1161 is formed between the pair of actuators 113. The first common liquid chamber 1161 forms a flow path of the ink from the supply opening 1111 to the one openings of the plurality of pressure chambers 1131 of each of the actuators 113. Further, the first common liquid chamber 1161 forms flow paths of the ink from the supply opening 1111 to the two third common liquid chambers 1163 in both end portions in the longitudinal direction (i.e., the first direction X) of the first common liquid chamber 1161 (i.e., the actuators 113).

The second common liquid chambers 1162 are each formed between each of the actuators 113 and the frame body 112. The second common liquid chambers 1162 form flow paths of the ink from the third common liquid chambers 1163 to the other openings of the plurality of pressure chambers 1131.

The third common liquid chambers 1163 are adjacent to, for example, the both ends in the longitudinal direction of the actuators 113. The third common liquid chambers 1163 communicate the first common liquid chamber 1161 and the two second common liquid chambers 1162 with each other at the both ends in the longitudinal direction of the pair of actuators 113. The third common liquid chambers 1163 form flow paths of some ink which reaches the second common liquid chambers 1162 from the first common liquid chamber 1161 without passing through the plurality of pressure chambers 1131 of each of the actuators 113. Further, the third common liquid chamber 1163 forms flow paths of the ink from the first common liquid chamber 1161 and the two second common liquid chambers 1162 to the discharge openings 1112.

As shown in FIG. 1 through FIG. 8, the manifold unit 12 is provided with a manifold 121, a top plate 122, ink supply tubes 123, ink discharge tubes 124, a first temperature control liquid supply tube 125, a first temperature control liquid discharge tube 126, dampers 127, and bypass flow paths 128. It should be noted that the number of the ink supply tubes 123 and the ink discharge tubes 124 can appropriately be set. It should be noted that the number of the ink supply tubes 123, the ink discharge tubes 124, the first temperature control liquid supply tubes 125, and the first temperature control liquid discharge tubes 126 can appropriately be set.

The manifold 121 is formed to have a plate-like shape or a block-like shape. As shown in FIG. 6 through FIG. 8, the manifold 121 is provided with supply channels 1211 which are communicated with the supply openings 1111 of the base plates 111 to form liquid supply flow paths, discharge channels 1212 which are communicated with the discharge openings 1112 of the base plates 111 to form liquid discharge paths, and first temperature control flow paths 1213 which form flow paths of a fluid such as a temperature control liquid for controlling the temperature. It should be noted that the manifold 121 is coupled to the pair of head main bodies 11, and therefore has a pair of the supply channels 1211 and a pair of the discharge channels 1212.

One of the principal surfaces of the manifold 121 is fixed to the principal surface of the base plate 111. Further, the top plate 122 is fixed to an opposite principal surface of the manifold 121 to the principal surface thereof to which the base plate 111 is fixed. Further, the ink supply tubes 123, the ink discharge tubes 124, the first temperature control liquid supply tube 125, and the first temperature control liquid discharge tube 126 are fixed to the manifold 121 via, for example, the top plate 122.

The manifold 121 is provided with, for example, a first manifold 1214 and a second manifold 1215. The manifold is formed by integrally assembling the first manifold 1214 and the second manifold 1215.

The supply channel 1211 is a liquid chamber which is provided to the manifold 121 using a hole and a groove, and which has a rectangular solid shape elongated in one direction (i.e., the first direction X). The supply channel 1211 fluidically couples the ink supply tubes 123 and the supply openings 1111 of the base plate 111 to each other.

For example, the supply channel 1211 a liquid chamber having a rectangular solid shape extending along the longitudinal direction of the actuator 113 and the longitudinal direction of the supply opening 1111. The supply channel 1211 is a flow path of the liquid between the ink supply tube 123 and the supply opening 1111. The supply opening 1111 is communicated with one side of the supply channel 1211, and the damper 127 is disposed in a ceiling part 12111 at the other side of the supply channel 1211.

The discharge channel 1212 is a flow path provided to the manifold 121 using a hole and a groove. The discharge channel 1212 fluidically couples the ink discharge tube 124 and the two discharge openings 1112 of the base plate 111 to each other.

The first temperature control flow path 1213 is a flow path provided to the manifold 121 using a hole and a groove. The first temperature control flow path 1213 fluidically couples the first temperature control liquid supply tube 125 and the first temperature control liquid discharge tube 126 to each other. The first temperature control flow path 1213 controls the temperature of the head main body 11 as a liquid ejection unit.

The both ends at the primary side and the secondary side of the first temperature control flow path 1213 are openings to be coupled to the first temperature control liquid supply tube 125 and the first temperature control liquid discharge tube 126 disposed on one principal surface of the manifold 121. Further, the first temperature control flow path 1213 is formed so as to be able to exchange heat with the base plate 111 fixed to the manifold 121.

The first manifold 1214 is formed to have a rectangular plate-like shape. The first manifold 1214 is provided with grooves and openings forming, for example, a part of the pair of supply channels 1211, a part of the pair of discharge channels 1212, and a part of the first temperature control flow paths 1213. The arrangement, the sizes, and so on of the grooves and the openings forming a part of the supply channels 1211 and the discharge channels 1212 are appropriately set based on the shapes of the supply channels 1211 and the discharge channels 1212 and the shapes of other fluid flow paths.

The second manifold 1215 is formed to have a rectangular plate-like shape. The second manifold 1215 is provided with grooves and openings forming, for example, a part of the pair of supply channels 1211, a part of the pair of discharge channels 1212, and a part of the first temperature control flow paths 1213. The arrangement, the sizes, and so on of the grooves and the openings forming a part of the supply channels 1211 and the discharge channels 1212 are appropriately set based on the shapes of the supply channels 1211 and the discharge channels 1212 and the shapes of other fluid flow paths.

Such first manifold 1214 and second manifold 1215 are integrally bonded to each other to thereby form the supply channels 1211, the discharge channels 1212, and the first temperature control flow paths 1213.

The top plate 122 is disposed on an opposite surface of the manifold 121 to the surface on which the base plate 111 is disposed. The top plate 122 has openings for communicating the ink supply tubes 123, the ink discharge tubes 124, the first temperature control liquid supply tube 125, and the first temperature control liquid discharge tube 126 with the supply channels 1211, the discharge channels 1212, and the first temperature control flow paths 1213. For example, the top plate 122 is formed of two plate-like members. One of the plate-like members is provided with one of the ink supply tubes 123 and the ink discharge tubes 124, and one of the first temperature control liquid supply tube 125 and the first temperature control liquid discharge tube 126. Further, the other of the plate-like members is provided with the other of the ink supply tubes 123 and the ink discharge tubes 124, and the other of the first temperature control liquid supply tube 125 and the first temperature control liquid discharge tube 126.

The ink supply tubes 123 are coupled to the supply channels 1211. The ink discharge tubes 124 are coupled to the discharge channels 1212. Since the liquid ejection head 1 is provided with the pair of head main bodies 11, a pair of the ink supply tubes 123 and a pair of the ink discharge tubes 124 are also disposed. The first temperature control liquid supply tube 125 and the first temperature control liquid discharge tube 126 are coupled to the primary side and the secondary side of the first temperature control flow path 1213.

The pair of ink supply tubes 123 and the first temperature control liquid discharge tube 126 are arranged at one end side in the longitudinal direction of the manifold 121, and the pair of ink discharge tubes 124 and the first temperature control liquid supply tube 125 are arranged at the other end side in the longitudinal direction of the manifold 121.

As shown in FIG. 6 through FIG. 8, the damper 127 is formed like an elastically deformable thin-film or an elastically deformable sheet. As shown in FIG. 7, the damper 127 covers the ceiling part 12111 of the supply channel 1211 provided to the second manifold 1215. The damper 127 elastically deforms in accordance with a pressure fluctuation in the supply channel 1211. One surface of the damper 127 is opposed to the supply channel 1211.

For example, the damper 127 is formed of a film made of polyimide. The damper 127 is formed to have a rectangular shape elongated in the same direction as the longitudinal direction (i.e., the first direction X) of the opening of the ceiling part 12111 of the supply channel 1211 elongated in one direction (i.e., the first direction X).

As shown in FIG. 6, the bypass flow path 128 couples the ceiling part 12111 of the supply channel 1211 and the common liquid chamber 116 or the secondary side of the common liquid chamber 116 to each other. It should be noted that the common liquid chamber 116 or the secondary side of the common liquid chamber 116 to which the bypass flow path 128 is coupled means, for example, the second common liquid chamber 1162 or the third common liquid chamber 1163 of the common liquid chamber 116, the discharge channel 1212, or the ink discharge tube 124. The fluid resistance of the bypass flow path 128 is higher than the fluid resistance of the supply channel 1211 and the fluid resistance of the common liquid chamber 116.

The bypass flow path 128 bypasses the supply channel 1211 and the common liquid chamber 116 to thereby discharge bubbles in the supply channel 1211 when performing maintenance or loading the ink. The bypass flow path 128 is formed so that the cross-sectional shape of the flow path is a rectangular shape or a circular shape. The bypass flow path 128 is formed to have, for example, a linear shape or a bent shape having a bend in a part thereof.

As shown in FIG. 2, FIG. 4, and FIG. 10, the temperature control flow path unit 13 for controlling the temperature is provided with, for example, a temperature control flow path section 131, flow path top plates 132, a second temperature control liquid supply tube 133, and a second temperature control liquid discharge tube 134. The temperature control flow path unit 13 is coupled to the temperature control device 2116 of the liquid ejection apparatus 2. The temperature control flow path unit 13 has a temperature control structure for cooling the driver ICs 142 as the heat generating circuits with the temperature control liquid. It should be noted that the temperature control flow path unit 13 is only required to have a configuration of controlling the temperature, and can adopt a configuration of performing heating in addition to cooling or instead of cooling. That is, the temperature control flow path unit 13 is a temperature control flow path unit through which the temperature control liquid which performs cooling and/or heating flows, and can be a temperature control structure capable of controlling the driver ICs 142 as the heat generating circuits to have a desired temperature.

The temperature control flow path section 131 is coupled to the second temperature control liquid supply tube 133 and the second temperature control liquid discharge tube 134 via the flow path top plates 132. The temperature control flow path section 131 is provided with a blanch flow path 1311 to be coupled to the second temperature control liquid supply tube 133, a second temperature control flow path 1312 for controlling the temperature of the plurality of driver ICs described later as the heat generating part, and a merging flow path 1313.

The blanch flow path 1311 blanches the temperature control liquid supplied from the second temperature control liquid supply tube 133 into two directions. One of the flow paths branched into by the branch flow path 1311 is coupled to the first temperature control flow path 1213, and the other of the flow paths branched into by the branch flow path 1311 is coupled to the second temperature control flow path 1312.

The second temperature control flow path 1312 is coupled to one of the flow paths branched into by the branch flow path 1311. The second temperature control flow path 1312 forms a flow path which is branched at the primary side into a number of flow paths no smaller than two and smaller than the number of the driver ICs, and is then merged integrally at the secondary side. The second temperature control flow path 1312 controls the temperature of the driver ICs 142.

For example, there are disposed four nozzle arrays 1142, four columns of actuators 113, and four columns of driver ICs 142. Therefore, as shown in FIG. 2, FIG. 4, and FIG. 10, the temperature control flow path section 131 has three flow path parts 13121 which form the second temperature control flow path 1312. The three flow path parts 13121 are elongated in one direction (i.e., the first direction X), and are arranged side by side in a direction (i.e., the second direction Y) perpendicular to the longitudinal direction of the flow path parts 13121.

The three flow path parts 13121 are formed of a pair of single-column temperature control flow path parts 13122, and a single multiple-column temperature control flow path part 13123. Outer side surfaces of the flow path parts 13121 have contact with the driver ICs 142 as the heat generating circuits, and thus, the flow path parts 13121 form a temperature control block for controlling the temperature of the driver ICs 142. The pair of single-column temperature control flow path parts 13122 are disposed at both ends (i.e., on the outer side) in the arrangement direction (i.e., the second direction Y) of the three flow path parts 13121. The pair of single-column temperature control flow path parts 13122 each control the temperature of the single driver IC 142 for driving the actuator 113 which ejects the ink from the single nozzle array 1142. The outer surface of the single-column temperature control flow path part 13122 has contact with the driver IC 142 corresponding thereto.

The multiple-column temperature control flow path part 13123 is disposed on the inner side in the arrangement direction (i.e., the second direction Y) of the three flow path parts 13121. In other words, the multiple-column temperature control flow path part 13123 is disposed between the pair of single-column temperature control flow path parts 13122 in the arrangement direction (i.e., the second direction Y) of the three flow path parts 13121. The multiple-column temperature control flow path part 13123 controls the temperature of the two driver ICs 142 for respectively driving the two actuators 113 which eject the ink from the two nozzle arrays 1142 adjacent to each other of the two sets of head main body 11. The outer surfaces different from each other of the multiple-column temperature control flow path part 13123 have contact with the two driver ICs 142 corresponding thereto.

For example, as shown in FIG. 4, the width WA of the flow path 131221 formed by the single-column temperature control flow path part 13122 is narrower in dimension than the width WB of the flow path 131231 formed by the multiple-column temperature control flow path part 13123. The width WA of the flow path 131221 and the width WB of the flow path 131231 are each a width in the second direction Y. Further, the cross-sectional area of the flow path 131221 formed by the single-column temperature control flow path part 13122 is smaller than the cross-sectional area of the multiple-column temperature control flow path part 13123. This is because, the single-column temperature control flow path part 13122 controls the temperature of the single driver IC 142, while the multiple-column temperature control flow path part 13123 controls the temperature of the two driver ICs 142. Therefore, in order to make the multiple-column temperature control flow path part 13123 higher in temperature control capacity than the single-column temperature control flow path part 13122, the width WB of the flow path 131231 of the multiple-column temperature control flow path part 13123 is larger than the width WA of the flow path 131221 of the single-column temperature control flow path part 13122.

The merging flow path 1313 merges the first temperature control flow path 1213 and the second temperature control flow path 1312 with each other to couple the first temperature control flow path 1213 and the second temperature control flow path 1312 to the second temperature control liquid discharge tube 134.

Such a temperature control flow path section 131 is provided with, for example, a temperature controlling manifold 1314, a cover 1315 for covering the temperature controlling manifold 1314, and a pair of flow path blocks 1316 provided to the cover 1315.

The second temperature control flow path 1312 is a flow path formed of a hole and a groove provided to the temperature controlling manifold 1314, the cover 1315, and the pair of flow path blocks 1316.

The temperature controlling manifold 1314 is formed to have a plate-like shape or a block-like shape. The temperature controlling manifold 1314 is fixed to, for example, the manifold 121. The temperature controlling manifold 1314 is provided with two openings 13141 in which a part of the wiring film 141 on which the driver IC 142 described later is mounted and the printed wiring board 143 of the circuit board 14 are arranged. The opening 13141 extends along the longitudinal direction (i.e., the first direction X) of the flow path part 13121.

Three regions adjacent to the two openings 13141 of the temperature controlling manifold 1314 respectively form a part of the three flow path parts 13121. The temperature controlling manifold 1314 is provided with, for example, a groove 13142. The groove 13142 has a shape in which three flow paths as the flow paths 131221 formed by the two single-column temperature control flow path parts 13122 and the flow path 131231 formed by the single multiple-column temperature control flow path 13123 are branched from a single flow path, and then the three flow paths are merged with each other.

The cover 1315 is formed to have a plate-like shape. The cover 1315 is provided with two openings 13151 in which a part of the wiring film 141 and the printed wiring board 143 are disposed, and which extend along the longitudinal direction (i.e., the first direction X) of the flow path part 13121. The cover 1315 covers the groove 13142 provided to the temperature controlling manifold 1314, and is liquid-tightly fixed to the temperature controlling manifold 1314. The cover 1315 forms the second temperature control flow path 1312 together with the temperature controlling manifold 1314. When the cover 1315 is assembled integrally with the temperature controlling manifold 1314, the two openings 13151 of the cover 1315 and the openings 13141 of the temperature controlling manifold 1314 are opposed to each other. The cover 1315 is provided with a plurality of openings for communicating, for example, the second temperature control flow path 1312 with the branch flow path 1311 and the merging flow path 1313.

The flow path block 1316 is provided with a groove and an opening for forming the branch flow path 1311 or the merging flow path 1313 inside. Specifically, one of the pair of flow path blocks 1316 forms the branch flow path 1311, and the other of the pair of flow path blocks 1316 forms the merging flow path 1313. Further, the pair of flow path blocks 1316 are fixed to the cover 1315. The pair of flow path blocks 1316 are opposed in the first direction X to each other at a distance enough to dispose the wiring film 141 of the circuit board 14 and the printed wiring board 143 described later. The flow path block 1316 has, for example, a tubular part 13161 which couples the branch flow path 1311 or the merging flow path 1313 to the first temperature control liquid supply tube 125 or the first temperature control liquid discharge tube 126. Further, the flow path block 1316 is provided with, for example, a plurality of ribs 13162 which arrange the printed wiring boards 143 described later of the four circuit boards 14, and which support one principal surfaces of the printed wiring boards 143, and a plurality of grooves 13163 which hold plate spring parts 162 of the holding members 16 together with the flow path top plates 132.

The same number of ribs 13162 as the number of printed wiring boards 143 are disposed. For example, one principal surface of one printed wiring board 143 has contact due to the pair of ribs 13162 corresponding thereto provided to the pair of flow path blocks 1316. The printed wiring board 143 has contact with the rib 13162, and the rib 13162 functions as a guide which defines the position of the printed wiring board 143 by holding the printed wiring board 143 together with the holding member 16.

The same number of grooves 13163 as the number of the printed wiring boards 143, in other words, the total number of the plate spring parts 162 are provided to each of the flow path blocks 1316. The grooves 13163 are formed so that the plate spring parts 162 described later of the holding member 16 can be arranged.

The flow path top plate 132 is disposed on an opposite surface of the pair of flow path blocks 1316 to the surface on which the cover 1315 is disposed. For example, a pair of the flow path top plates 132 are disposed. Each of the flow path top plates 132 has an opening for coupling the second temperature control liquid supply tube 133 or the second temperature control liquid discharge tube 134 to the branch flow path 1311 or the merging flow path 1313 of the flow path block 1316. The flow path top plate 132 is provided with, for example, a plurality of grooves 1321 in which the plate spring parts 162 of the holding member 16 are disposed to be supported, and regions between the two grooves 1321 adjacent to each other hold a base part 161 described later of the holding member 16.

The grooves 1321 are provided as much as the number of the printed wiring boards 143, in other words, as much as the total number of the plate spring parts 162 provided to the holding member 16, to each of the flow path top plates 132. The plurality of grooves 1321 of the flow path top plate 132 is opposed to the grooves 13163 provided to the flow path block 1316 in an opposing direction (i.e., the third direction Z) of the flow path block 1316 and the flow path top plate 132, and the plate spring part 162 is disposed in the grooves 13163, 1321 which are opposed to each other and continue in the third direction Z.

As shown in FIG. 1 through FIG. 4, one end of the circuit board 14 is coupled to the wiring pattern of the actuator 113 via the wiring pattern of the base plate 111. The circuit board 14 is provided with, for example, the wiring film 141, the driver IC 142 installed in the wiring film, and the printed wiring board 143 mounted on the wiring film.

The circuit board 14 applies the drive voltages to the actuator 113 via the wiring pattern of the base plate 111 with the driver IC 142 to thereby drive the actuator 113 to increase or decrease the volumes of the pressure chambers 1131 to eject droplets from the nozzles 1141.

The wiring film 141 is a film board which is formed to have a so-called film-like shape, and which is provided with the wiring pattern. There is disposed, for example, a plurality of wiring films 141. The wiring film 141 is, for example, a COF (Chip on Film) on which the driver IC 142 is mounted. For example, the same number of wiring films 141 as, for example, the number of actuators 113 provided to the single head main body 11, namely, the number of nozzle arrays 1142 are provided. Further, each of the wiring films 141 is coupled to the single actuator 113.

It should be noted that there may be adopted a configuration in which the plurality of wiring films 141 is coupled to the single actuator 113, and in this case, the number of the wiring film columns formed of the plurality of wiring films 141 and the number of the driver IC columns formed of the driver ICs 142 installed in the wiring films 141 become the same as the number of columns of the actuators 113. As an example in which the plurality of wiring films 141 is coupled to the single actuator 113 as described above, there can be cited the liquid ejection head 1 in which two wiring films 141 each loading a single driver IC 142 are coupled to each of the four actuators 113, and which has totally eight wiring films 141.

Since the head main body 11 has the configuration in which the two columns of nozzle arrays 1142 (i.e., the two actuators 113) are disposed, the two wiring films 141 are provided to the single head main body 11. Further, the liquid ejection head 1 having the two sets of head main body 11 has the four wiring films 141. The four wiring films 141 are arranged, for example, so as to extend in the third direction Z, and are arranged side by side in the second direction Y in this posture. Further, although the example in which a single driver IC 142 is mounted on each of the wiring films 141 is described in the present embodiment, two or more driver ICs 142 may be mounted on a single wiring film 141.

The driver IC 142 is electrically coupled to the wiring pattern formed in the pressure chambers 1131 via the wiring film 141. The driver IC 142 is the heat generating part which generates heat. The driver IC 142 is mounted at the outer surface side of the wiring film 141. Here, in the posture in which the wiring film 141 is arranged so as to extend in the third direction Z, the outer surface side of the wiring film 141 means a surface at an opposite side to an inner surface at the side at which the two wiring films 141 of the single head main body 11 are opposed to each other. In other words, the outer side of the wiring film 141 means an outer side in the second direction Y of the head main body 11 when defining the central side in the second direction Y of the head main body 11 as an inner side. Therefore, out of the four wiring films 141 of the two sets of head main body 11, the outer surfaces of the inner two wiring films 141 are opposed to each other.

In the driver IC 142, a surface at an opposite side to the mounting surface with which the driver IC 142 is mounted on the wiring film 141 has contact with the outer surface of the flow path part 13121. For example, the surface of the driver IC 142 has direct contact with the outer surface of the flow path part 13121. A single driver IC 142 is provided to a single wiring film 141. It should be noted that when a plurality of driver ICs 142 is provided for driving a single actuator 113, the plurality of driver ICs 142 is mounted on one or more wiring films 141 to form the same number of the driver IC columns as the number of the actuators 113, and the plurality of driver ICs 142 in the same driver IC column has contact with corresponding one of the flow path parts 13121.

The printed wiring board 143 is, for example, a PWA (Printing Wiring Assembly) on which a variety of electronic components and connectors are mounted. The printed wiring board 143 is coupled to corresponding one of the driver ICs 143 via the wiring film 141. The same number of printed wiring boards 143 as the number of the actuators 113 are disposed. Therefore, the liquid ejection head 1 having the two sets of head main body 11 has the four printed wiring boards 143. The four printed wiring boards 143 are arranged, for example, so that the surface direction is parallel to the first direction X and the third direction Z, and are arranged side by side in the second direction Y in this posture. Mounting components such as a variety of electronic components and connectors are mounted on one principal surface of the printed wiring board 143. It should be noted that the mounting components may be mounted on both surfaces of the printed wiring board 143, but in the principal surface opposed to the plate spring part 162 described later, the mounting components are mounted around an area where the plate spring part 162 is disposed.

The cover 15 covers or houses a part of the head main bodies 11, a part of the manifold unit 12, and the circuit boards 14.

The holding member 16 is a plate spring which has contact with and presses the driver ICs 142 and the printed wiring boards 143 to thereby hold the driver ICs 142 and the printed wiring boards 143 together with other members having contact with the driver ICs 142 and the printed wiring boards 143 than the holding member 16.

The number of holding members 16, for example, equal to half the number of actuators 113 (i.e., the nozzle arrays 1142), namely, equal to the number of pairs of actuators 113 are provided. In other words, the holding members 16 are provided half as much as the number of the plurality of printed wiring boards 143 corresponding to the plurality of actuators 113, and press the driver ICs 142 and the printed wiring boards 143 adjacent in the arrangement direction to each other. Since there is adopted the configuration in which the four printed wiring boards 143 are provided, the two holding members 16 are provided. The holding member 16 is provided with, for example, the base part 161, and a pair of plate spring parts 162 integrally provided to the base part 161. For example, the holding member 16 is formed by performing a bending work or the like on a flat plate which is shaped to have the shape of the base part 161 as a blank and the pair of plate spring parts 162, and which is made of, for example, a metal material.

The base part 161 is formed to have a flat plate-like shape elongated in one direction. The base part 161 is formed so that the length in the longitudinal direction is longer than a distance between the opposed surfaces of the pair of flow path top plates 132 opposed in the first direction X to each other. Further, the base part 161 is formed so that the length in the transverse direction is the same as the distance between the grooves 1321 adjacent to each other provided to the flow path top plate 132. That is, the base part 161 is formed so that both ends in the longitudinal direction can have contact with upper surfaces at the opposed surface side of the pair of flow path top plates 132, and so that the pair of plate spring parts 162 provided integrally to end portions in the transverse direction of the base part 161 can be disposed in the grooves 13163, 1321.

The plate spring part 162 extends from the end portion in the transverse direction of the base part 161 in a direction along the third direction Z perpendicular to both the longitudinal direction and the transverse direction of the base part 161, or a direction slightly oblique to the third direction Z. For example, the pair of plate spring parts 162 extend from the base part 161 in a direction slightly oblique to the third direction Z so that the distance in the opposing direction of the pair of plate spring parts 162 gradually increases as getting away from the base part 161. The plate spring parts 162 are provided with first holding parts 1621 which press to hold the driver ICs 42, and a pair of second holding parts 1622 which press to hold the printed wiring boards 143.

The first holding part 1621 extends from the base part 161 up to a position opposed to the driver IC 142 in the third direction Z, and is partially bent so as to protrude outward in a region opposed to the driver IC 142 to thereby be formed to have a protruding shape. For example, by the region opposed to the driver IC 142 gradually extending outward from the base part 161 side, and then gradually extending inward toward the end portion at the opposite side to the base part 161 side, the first holding part 1621 protrudes outward to form a chevron shape. Further, for example, when the driver ICs 142 adjacent in the arrangement direction (i.e., the second direction Y) to each other are different in height position in the third direction Z perpendicular to the arrangement direction, the first holding parts 1621 of the pair of plate spring parts 162 become different in height position in the third direction Z from each other.

In the arrangement direction of the pair of first holding parts 1621 (i.e., the arrangement direction of the driver ICs 142 or the second direction Y), the holding member 16 is formed so that a distance between vertex portions protruding toward the outside of the pair of first holding parts 1621 is longer than a distance between the driver ICs 142 adjacent to each other. Therefore, the first holding parts 1621 have contact with the driver ICs 142, and then press the driver ICs 142 toward the flow path parts 13121 having contact therewith. Thus, each of the driver ICs 142 is clamped with the outer surface of the flow path part 13121 and the vertex portion (i.e., the tip) of the first holding part 1621, and is held.

The pair of second holding parts 1622 are disposed at respective positions different in the longitudinal direction (i.e., the first direction X) of the base part 161, and press the printed wiring boards 143 at the positions different in the first direction X from each other. Specifically, in the single holding member 16, two sets of the pair of second holding parts 1622 opposed in the arrangement direction of the pair of plate spring parts 162 to each other are provided to the pair of plate spring parts 162.

The second holding part 1622 extends from the base part 161 up to a predetermined region of the printed wiring board 143 in the third direction Z, and is partially bent so as to protrude outward at a position opposed to the printed wiring board 143 to thereby be formed to have a protruding shape. For example, by the region opposed to the printed wiring board 143 gradually extending outward from the base part 161 side, and then gradually extending inward toward the end portion at the opposite side to the base part 161 side, the second holding part 1622 protrudes outward to form a chevron shape.

In the arrangement direction of the two sets of the pair of second holding parts 1622 (i.e., the arrangement direction of the printed wiring boards 143 or the second direction Y), the holding member 16 is formed so that the distance between the vertex portions (i.e., the tips) protruding toward the outside of the pair of second holding parts 1622 corresponding to each other, namely the two second holding parts 1622 which are provided to the different plate spring parts 162, and which are opposed in the second direction Y to each other, is larger than the distance between the printed wiring boards 143 adjacent to each other. Therefore, each of the pairs of second holding parts 1622 have contact with the printed wiring boards 143 at positions different in the first direction X from each other, and then press the printed wiring boards 143 toward the pair of ribs 13162 having contact therewith. Thus, each of the printed wiring boards 143 is clamped with the outer surfaces of the pair of ribs 13162 and the vertex portions (i.e., the tips) of the second holding parts 1622, and is held.

An example of assembly of such a holding member 16 will be described. For example, first, after assembling the head main bodies 11, the manifold unit 12, the temperature control flow path unit 13, and the circuit boards 14 integrally with each other, the pair of plate spring parts 162 are inserted from the end portion side as an opposite side to the base part 161 between the printed wiring boards 143 adjacent to each other and corresponding thereto. Then, both ends in the longitudinal direction (i.e., the first direction X) of the pair of plate spring parts 162 are inserted into the grooves 13163, 1321 forming the two sets of pair adjacent to each other provided to the pair of flow path blocks 1316 and the pair of flow path top plates 132, and the both ends in the longitudinal direction (i.e., the first direction X) of the base part 161 are brought into contact with the upper surfaces of the pair of flow path top plates 132. Thus, the positioning of the holding member 16 is achieved.

On this occasion, the first holding part 1621 and the pair of second holding parts 1622 of each of the plate spring parts 162 become the same in position in the insertion direction (i.e., the third direction Z) of the holding member 16 as the driver IC 142 and the printed wiring board 143, respectively. Thus, the first holding part 1621 and the pair of second holding parts 1622 respectively press the driver IC 142 and the printed wiring board 143 to thereby hold the driver IC 142 and the printed wiring board 143. It should be noted that the first holding part 1621 clamps the driver IC 142 with the flow path part 13121, and the pair of second holding parts 1622 clamp the printed wiring board 143 with the pair of ribs 13162.

Further, the holding member 16 is a plate spring, and the first holding part 1621 deforms elastically when clamping the driver IC 142 with the flow path part 13121, and the pair of second holding parts 1622 deform elastically when clamping the printed wiring board 143 with the pair of ribs 13162. Therefore, the pair of plate spring parts 162 of the holding member 16 are clamped by the driver IC 142 and the printed wiring board 143 adjacent in the arrangement direction to each other, and are held. As described above, since the holding member 16 is held by the two driver ICs 142 and the two printed wiring boards 143 adjacent in the arrangement direction to each other as a result due to its own restorative force when the holding member 16 is positioned, and holds the two driver ICs 142 and the two printed wiring boards 143 adjacent in the arrangement direction to each other, a member for fixing the holding member 16 is not required.

The liquid ejection head 1 configured as described above includes the first temperature control flow path 1213 for controlling the temperature of the head main bodies 11 as the liquid ejection unit and the second temperature control flow path 1312 for controlling the temperature of the driver ICs 142 as the heat generating part using the manifold unit 12 and the temperature control flow path unit 13. The temperature control liquid supplied from the second temperature control liquid supply tube 133 passes through the first temperature control flow path 1213 and the second temperature control flow path 1312, and is then discharged from the second temperature control liquid discharge tube 134. Then, the temperature control liquid flowing through the first temperature control flow path 1213 controls the temperature of the head main bodies 11, and the temperature control liquid flowing through the second temperature control flow path 1312 controls the temperature of the driver ICs 142.

Further, it is sufficient for the second temperature control flow path 1312 to have a simple configuration in which the driver ICs 142 are made to have contact with the outer surfaces of the plurality of flow path parts 13121 through which the temperature control liquid passes.

Further, by inserting the holding member 16 between the driver ICs 142 adjacent in the arrangement direction (i.e., the second direction Y) to each other and between the printed wiring boards 143 adjacent to each other, it is possible to clamp the driver ICs 142 between the first holding parts 1621 and the flow path parts 13121 to hold the driver ICs 142, and further, it is possible to clamp the printed wiring boards 143 between the pairs of second holding parts and the pairs of ribs 13162 to hold the printed wiring boards 143.

Further, the holding member 16 is inserted into a space formed between the driver ICs 142 and the printed wiring board 143 adjacent to each other arranged at a predetermined distance in the arrangement direction (i.e., the second direction Y). Therefore, since the holding member 16 does not require to additionally provide a space for holding the driver ICs 142 and the printed wiring boards 143, it is possible to prevent the liquid ejection head 1 from growing in size. Further, since the holding member 16 is positioned in the third direction Z with the temperature control flow path unit 13, and elastically deforms to thereby hold the driver ICs 142 and the printed wiring boards 143 with spring force, it is possible to easily hold the driver ICs 142 and the printed wiring boards 143. Further, by providing the protruding shape to the first holding parts 1621 and the second holding parts 1622 of the holding member 16, the width at the end portion side between the holding parts 1621, 1622 forming the pairs becomes smaller than the width of the vertex portion, and therefore, it becomes easy to insert the holding member 16 between the printed wiring boards 143 adjacent to each other.

The liquid ejection apparatus 2 having the liquid ejection head 1 will hereinafter be described with reference to FIG. 12. The liquid ejection apparatus 2 is provided with a chassis 2111, a medium supply unit 2112, an image forming unit 2113, a medium discharge unit 2114, a conveyance device 2115 as a support device, a temperature control device 2116, a maintenance device 2117, and a control unit 2118.

The liquid ejection apparatus 2 is an inkjet printer which ejects a liquid such as ink while conveying, for example, a sheet P as a recording or printing medium which is an ejection target along a predetermined conveyance path 2001 from the medium supply unit 2112 to the medium discharge unit 2114 through the image forming unit 2113 to thereby perform image forming processing on the sheet P.

The medium supply unit 2112 is provided with a plurality of paper cassettes 21121. The image forming unit 2113 is provided with a support unit 2120 for supporting the sheet, and a plurality of head units 2130 disposed above the support unit 2120 so as to be opposed to the support unit 2120. The medium discharge unit 2114 is provided with a catch tray 21141.

The support unit 2120 is provided with a conveyance belt 21201 provided to a predetermined area for performing the image formation to have a loop shape, a support plate 21202 for supporting the conveyance belt 21201 from a reverse side, and a plurality of belt rollers 21203 provided at the reverse side of the conveyance belt 21201.

The head unit 2130 is provided with the liquid ejection heads 1 as a plurality of inkjet heads, a plurality of supply tanks 2132 as liquid tanks respectively mounted on the liquid ejection heads 1, pumps 2134 for supplying the ink, and coupling flow paths 2135 for coupling the liquid ejection heads 1 and the supply tanks 2132 to each other.

There are provided the liquid ejection heads 1 of four colors, namely cyan, magenta, yellow, and black, as the liquid ejection heads 1, and the supply tanks 2132 of the four colors for respectively containing the ink of these colors. The supply tanks 2132 are coupled to the liquid ejection heads 1 with the coupling flow paths 2135, respectively.

The pumps 2134 are each a liquid feeding pump formed of, for example, a piezoelectric pump. The pumps 2134 are coupled to the control unit 2118, and are subjected to drive control by the control unit 2118.

The coupling flow paths 2135 are each provided with a supply flow path to be coupled to the ink supply tubes 123 of the liquid ejection head 1. Further, the coupling flow paths 2135 are each provided with a collection flow path to be coupled to the ink discharge tubes 124 of the liquid ejection head 1. For example, since the liquid ejection head 1 is of the noncyclic type, the collection flow path is coupled to the maintenance device 2117. It should be noted that, for example, when the liquid ejection head 1 is of the cyclic type, the collection flow path is coupled to the supply tanks 2132.

The conveyance device 2115 conveys the sheet P along the conveyance path 2001 from the paper cassette 21121 of the medium supply unit 2112 to the catch tray 21141 of the medium discharge unit 2114 through the image forming unit 2113. The conveyance device 2115 is provided with a plurality of guide plate pairs 21211 through 21218 and a plurality of conveying rollers 21221 through 21228 arranged along the conveyance path 2001. The conveyance device 2115 supports the sheet P so as to be able to move relatively to the liquid ejection heads 1.

The temperature control device 2116 includes a temperature control liquid tank 21161, a temperature controlling circuit 21162 such as piping or tubes for supplying the temperature control liquid, a pump for supplying the temperature control liquid, a temperature controller for controlling the temperature of the temperature control liquid, and so on. The temperature control device 2116 supplies the temperature control liquid the temperature of which is controlled to a predetermined temperature with the temperature controller, and which is stored in the temperature control liquid tank 21161 to the second temperature control liquid supply tube 133 via the temperature controlling circuit 21162 due to the water feed by the pump. Further, the temperature control device 2116 collects the water which passed through the first temperature control flow path 1213 and the second temperature control flow path 1312, and was then discharged from the second temperature control liquid discharge tube 134 in the temperature control liquid tank 21161 via the temperature controlling circuit 21162. It should be noted that the temperature controller is, for example, a cooler.

The maintenance device 2117 suctions the ink remaining on outer surfaces of the nozzle plates 114 to collect the ink when, for example, performing the maintenance. Further, when the liquid ejection heads 1 are of the noncyclic type, the maintenance device 2117 collects the ink inside the head main bodies 11 through the nozzles 1141 when performing the maintenance. Such a maintenance device 2117 includes a tray, a tank, or the like for retaining the ink thus collected.

The control unit 2118 is provided with a CPU 21181 as an example of a processor, memory device such as a read only memory (ROM) for storing a variety of programs and so on, and a random access memory (RAM) for temporarily storing a variety of variable data, image data, and so on, and an interface unit for performing input of data from the outside and output of data to the outside.

In the liquid ejection head 1 and the liquid ejection apparatus 2 described above, by clamping the driver ICs 142 as the heat generating part and the printed wiring boards 143 between the holding member 16 and other elements using the holding member 16 as a plate spring, it is possible to easily hold the driver ICs 142 and the printed wiring boards 143 without growing in size.

It should be noted that embodiments of this disclosure are not limited to the configurations described above. For example, in the example described above, the head main bodies 11 are of the noncyclic type, but the cyclic type head main body may be adopted.

Further, in the example described above, the liquid ejection head 1 is provided with the four nozzle arrays. However, for example, a configuration in which the liquid ejection head 1 includes just one head main body 11 may be adopted, or a configuration in which there are three sets of the head main body 11, and there are six nozzle arrays may be adopted.

Further, in the example described above, the configuration in which the holding member 16 is provided with the pair of second holding parts 1622 in each of the plate spring parts 162 is described. However, the number of second holding parts 1622 provided to the plate spring part 162 may be one, or may also be three or more.

Further, two or more driver ICs 142 may be provided to a single actuator 113, and in such a case, it is possible to adopt a configuration in which the same number of first holding parts 1621 as the number of driver ICs 142 are provided to each of the plate spring parts 162, or it is possible to adopt a configuration in which the plurality of driver ICs 142 is held by a smaller number of first holding parts 1621 than the number of driver ICs 142.

Further, the configuration in which the driver ICs 142 are made to have contact with the outer surface of the flow path part 13121 is described above. However, the heat generator is not limited to the driver ICs 142, the element for controlling the temperature of the heat generator is not limited to the flow path parts 13121, and the element for controlling the temperature of the heat generator may be a temperature control member such as a heatsink or a heater. When adopting this configuration, it is sufficient for the holding member 16 to hold the temperature control member and the heat generator.

Further, the configuration in which the plate spring part 162 has the first holding part 1621 for holding the heat generator and the second holding part 1622 for holding the board is described above, but it is possible to adopt a configuration including a third holding part which clamps an element other than the heat generator and the board between the third holding part and other member to hold the element. That is, the number of elements clamped between the holding member 16 and other constituent members may appropriately be set.

Further, the example in which the liquid ejection head 1 and the liquid ejection apparatus 2 are used in the printing apparatus which ejects the ink as the liquid is described. However, the liquid ejection head 1 and the liquid ejection apparatus 2 can also be used in, for example, a 3D printer, an industrial manufacturing machine, and medical purposes.

According to at least one embodiment described hereinabove, the liquid ejection head can easily hold the heat generating part and the circuit board without growing in size.

Although some embodiments are described, these embodiments are illustrative only, but limiting the scope of the disclosure is not intended. These novel embodiments can be implemented with other various aspects, and a variety of omissions, replacements, and modifications can be made within the scope or the spirit of the present disclosure. These embodiments and the modifications thereof are included in the scope of the disclosure, and at the same time, included in the disclosure set forth in the appended claims and the equivalents thereof.

What is claimed is:

1. A liquid ejection head comprising:
a plurality of nozzle arrays extending along a first direction and through which liquid is ejected towards a second direction perpendicular to the first direction;
a plurality of substrates extending along the first and second directions, the substrates corresponding to the nozzle arrays;
a plurality of heat generating circuits each disposed on a corresponding one of the substrates;
a temperature control structure that contacts the heat generating circuits for controlling temperature thereof; and
one or more plate springs each biased to push one or more of the heat generating circuits against the temperature control structure.

2. The liquid ejection head according to claim 1, wherein
each of the plate springs contacts one or more of the substrates corresponding to said one or more of the heat generating circuits.

3. The liquid ejection head according to claim 2, wherein
each of the plate springs includes a first holding part that pushes one of the heat generating circuits at an end of the plate spring and a second holding part that contacts one of the substrates corresponding to said one of the heat generating circuits.

4. The liquid ejection head according to claim 1, wherein
a total number of the nozzle arrays is equal to a total number of the substrates and a total number of the heat generating circuits.

5. The liquid ejection head according to claim 4, wherein
the total number of the nozzle arrays is four, and
a total number of the plate springs is two.

6. The liquid ejection head according to claim 1, wherein
each of the plate springs is between two of the substrates that are adjacent to each other.

7. The liquid ejection head according to claim 6, wherein
each of the plate springs includes two first holding parts that push two heat generating circuits of said two of the substrates and two second holding parts that contact said two of the substrates.

8. The liquid ejection head according to claim 7, wherein
each of the first and second holding parts has a protruding shape, and
each of the two heat generating circuits is clamped between a tip of the protruding shape of one of the first holding parts and an outer surface of the temperature control structure.

9. The liquid ejection head according to claim 8, wherein
each of said two of the substrates is clamped between a tip of the protruding shape of one of the second holding parts and the outer surface of the temperature control structure.

10. The liquid ejection head according to claim 7, wherein each of the plate springs includes a base part connected to the first and second holding parts.

11. A liquid ejection apparatus comprising:
a head that includes:
a plurality of nozzle arrays extending along a first direction and through which liquid is ejected towards a second direction perpendicular to the first direction,
a plurality of substrates extending along the first and second directions, the substrates corresponding to the nozzle arrays,
a plurality of heat generating circuits each disposed on a corresponding one of the substrates,
a temperature control structure that contacts the heat generating circuits for controlling temperature thereof, and
one or more plate springs each biased to push one or more of the heat generating circuits against the temperature control structure;
a convenance belt by which a medium is conveyed towards the head; and
a controller configured to control the head to eject the liquid onto the medium.

12. The liquid ejection apparatus according to claim 11, wherein
each of the plate springs contacts one or more of the substrates corresponding to said one or more of the heat generating circuits.

13. The liquid ejection apparatus according to claim 12, wherein
each of the plate springs includes a first holding part that pushes one of the heat generating circuits at an end of the plate spring and a second holding part that contacts one of the substrates corresponding to said one of the heat generating circuits.

14. The liquid ejection apparatus according to claim 11, wherein
a total number of the nozzle arrays is equal to a total number of the substrates and a total number of the heat generating circuits.

15. The liquid ejection apparatus according to claim 14, wherein
the total number of the nozzle arrays is four, and
a total number of the plate springs is two.

16. The liquid ejection apparatus according to claim 11, wherein
each of the plate springs is between two of the substrates that are adjacent to each other.

17. The liquid ejection apparatus according to claim 16, wherein
each of the plate springs includes two first holding parts that push two heat generating circuits of said two of the substrates and two second holding parts that contact said two of the substrates.

18. The liquid ejection apparatus according to claim 17, wherein
each of the first and second holding parts has a protruding shape, and
each of the two heat generating circuit is clamped between a tip of the protruding shape of one of the first holding parts and an outer surface of the temperature control structure.

19. The liquid ejection apparatus according to claim 18, wherein
each of said two of the substrates is clamped between a tip of the protruding shape of one of the second holding parts and the outer surface of the temperature control structure.

20. The liquid ejection apparatus according to claim 17, wherein each of the plate springs includes a base part connected to the first and second holding parts.
